(19) United States
(12) Patent Application Publication
(10) Pub. No.: US 2016/0356465 A1
(43) Pub. Date: Dec. 8, 2016

(54) Automated Lighting System for Uniform Growth of Medical Cannabis

(71) Applicant: MICHAEL POLETE, Plantation, FL (US)

(72) Inventor: MICHAEL POLETE, Plantation, FL (US)

(21) Appl. No.: 14/731,398

(22) Filed: Jun. 4, 2015

(51) Int. Cl. F21V 21/15; A01G 9/20; A01G 7/04; H05B 37/02; H05B 33/08

(52) U.S. Cl. CPC F21V 21/15; H05B 37/029; H05B 33/0848; H05B 37/0281; A01G 7/045; A01G 9/20

(57) ABSTRACT

An automated system for uniform growth of medical cannabis includes at least one light source that is controlled from a master controller, so that the cannabis plant receives a consistent, uniform amount of light. The positioning of the light source and the wattage of the light source are adjustable. The horizontal and vertical displacement of the light source are performed through elongated horizontal and vertical support members. The support members are displaced with actuators that engage the support members directly. A camber bracket at the junction between the horizontal and vertical support members supports the weight, such that the horizontal support member remains level for uniform emitting of light. The master controller is preprogramed to displace the light, set a timer, and adjust the wattage. The power source is efficient, so as to minimize power usage.

### BACKGROUND

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The present invention is directed to an automated system for uniform growth of medical cannabis. The system provides indoor lighting for growing at least one cannabis plant. The system includes at least one light source that is controlled from a master controller, so that the cannabis plant receives a consistent amount of light. The positioning and wattage of the light source may be customized to desired specifications that conform to the needs of the cannabis plant.

It is known in the art that light is absorbed by plants and forms the basis of most food chains on Earth. Photons from the sun are absorbed by plants to convert carbon dioxide and water into carbohydrates. Photosynthesis is a complex multi-step chemical reaction that is powered by photons of specific wavelengths or energies. While sunlight has a broad spectrum that appears white, plants appear green since they reflect green and absorb light of other colors. Three principal characteristics of light affect plant growth: quantity (intensity or photon quantity), quality (light wavelength or color), and duration (time).

Those skilled in the art are also familiar that artificial light is been used both to provide supplemental or total light for plants. The light is generally of a spectrum which is most suitable for plant growth produced by relatively efficient lamps which have a relatively high lumen per watt ratio. These lighting systems generally utilize a number of point light sources spaced apart above the plants. The number of lamps used in these conventional lighting systems as well as the spacing of the lamps from each other and from the plants is selected to place a specific intensity of light on the plants.

The inventor has been a construction contractor for over 10 years. The inventor was proficient at solving construction and mechanical related problems for the construction and restaurant industry. The inventor was recently approached by indoor growers of legalized medical cannabis. The growers had problems producing consistent yields because the lighting, and other factors necessary to grow medical cannabis indoors was inconsistent. The medical cannabis plants were not receiving uniform lighting, or daily consistent lighting. Also, the growers wanted to customize the lighting, so that it could be changed for different strains of medical cannabis.

The inventor did some research to learn the root of the problem. The inventor learned that the employees responsible for maintaining the medical cannabis where sometimes negligent in the positioning of the lights. This resulted in the medical cannabis being underexposed or overexposed to the lights and thereby changed the yield or consistency of the each crop.

The inventor also learned that optimal indoor growing conditions for the medical cannabis required replication of outdoor lighting. This meant that the lights needed to be uniformly moved vertically or horizontally across the medical cannabis plants. The amount of lighting, i.e., wattage, also needed constant adjustment.

Through additional research, the inventor learned that a grid-like framework could be built over a crop of medical cannabis plants. The framework could be made from both horizontal and vertical bars that provided support to each other. The inventor build such a framework and added lights in a spaced-apart relationship along the horizontal bars. Thus, the lighting was now positioned over the medical cannabis plants and provided lighting.

The inventor noted that the weight of the lights would cause the horizontal bars to sag and deform. This resulted in uneven lighting by the attached lights. Being a construction contractor, the inventor knew that an arc shape was mathematically proven to be an excellent stress relief when applied to the joints and corners of building structures. The inventor added this arc-shaped dynamic to the junctions between horizontal and vertical bars in the form of camber brackets. The inventor noted that the camber brackets helped the framework maintain structural integrity to enable more uniform lighting over the medical cannabis plants.

However, the lights were stationary, and thus, still nonadjustable. The inventor decided to create a rail configuration for the horizontal bars and place horizontal actuators between bars to displace the entire coplanar section of the framework in a left and right direction. Then, for the supportive vertical bars (the legs), the inventor added vertical actuators in parallel alignment that would raise and lower the entire coplanar horizontal bar structure.

The inventor had thus, developed a horizontal and vertical displacement for the lights. Through additional research, the inventor learned that as electricity supplies fail to keep pace with demand, leading to ever higher prices, the need for more efficient plant growing lights increases. The inventor researched, and learned that the latest generation of high output LEDs, with their narrow light output wavelengths, would make a good choice for lighting the medical cannabis plants. Further, the LED's did not consume excessive energy, which allowed for power sources that were independent from the grid and utility companies.

However, the lighting was still not consistent because it still relied on manual intervention, which lead to human error. The inventor decided to include a microprocessor that could be preprogrammed to initiate the actuators and wattage for the LED's. In this manner, the system was fully automated, and would operate substantially free from manual intervention, except for occasional maintenance and repairs. The inventor developed a master controller for monitoring and controlling the preprogrammed parameters, as needed. This allowed the growers to really less on the maintenance workers, and thus, achieve more consistent yields and quality for the medical cannabis.

Finally, the inventor drew up future plans to further enhance the system with features, such as air quality control, water filtration, maintenance alerts, and creating synergies between multiple systems simultaneously.

For the foregoing reasons, there is an automated system for uniform growth of medical cannabis includes at least one light source that is controlled from a master controller, so that the cannabis plant receives a consistent, uniform amount of light. The positioning of the light source and the wattage of an LED are adjustably customizable to desired specifications that conform to the needs of the cannabis plant.

Plant lighting and growing systems and methods have been utilized in the past; yet none with the present delivery expediting characteristics of the present invention. See U.S. Patent No. 20020032613; U.S. Pat. No. 7,973,642; and 20130049932.

For the foregoing reasons, there is a need for an automated lighting system for the uniform growth of medical cannabis that will allow the grower to cultivate a uniform strand of medical cannabis.

### SUMMARY

The present invention describes an automated system for uniform growth of medical cannabis. The system provides indoor lighting for growing at least one cannabis plant. The system includes at least one light source that is controlled by a master controller, so that the cannabis plant receives a consistent amount of light. The positioning and wattage of the light source may be customized to desired specifications that conform to the needs of the cannabis plant. In this manner, cannabis plants, and specifically a medical cannabis plant, receives uniform lighting without the element of human error; and thereby optimal growth and yield for the cannabis plant is achieved.

In some embodiments, the system is automated, so that the proximity and position of the light source relative to the cannabis plant adjusts without requiring manual intervention. This light positioning may include both horizontal and vertical positioning of the light source. The automation further includes adjustability of the wattage in the light source. The proximity, horizontal position, and wattage of the light source may be simultaneously or independently adjusted. Furthermore, the system enables automation for powering on and off the light source, and timing the duration of the light. In this manner, the overall lighting needs of the cannabis plant are automated and adjustable to maintain a consistent light on the cannabis plant. The consistent light consequently provides a more consistent and productive cannabis plant yield.

In some embodiments, the system includes a plurality of first horizontal support members. The first horizontal support members are configured to carry at least one light source. The first horizontal support members are disposed in a parallel, spaced-apart relationship. The first horizontal support members are telescopically displaced in a horizontal direction, such as in a left to right movement.

In one possible embodiment, the first horizontal support members are configured into a rail configuration. For example, a pair of aligned first horizontal support members freely slide in and out of each other, enabling a telescopic interaction in a horizontal direction. The horizontal movement may be incrementally slow, or at a steady velocity, depending on the lighting requirements of the cannabis plant. The system enables the rate for the horizontal displacement to be controlled for customizable lighting.

In one embodiment, the first horizontal support members are configured to support multiple light sources that are disposed in a spaced-apart relationship above multiple cannabis plants. From this configuration, the light source is programmed to emit light onto the cannabis plant from multiple angles, heights, and wattages. Furthermore, the light source is maintained in a substantially level disposition relative to the cannabis plant. This creates a uniform transmission of light, which further optimizes growth of the cannabis plant.

In some embodiments, a plurality of second horizontal support members are disposed in a coplanar and perpendicular relationship to the first horizontal support members. The second horizontal support members form a pair of ends at the terminus of the first horizontal support members. The first horizontal support members align parallel and longitudinally, while the second horizontal support members form the ends to form an enclosed plane. In one embodiment, the first and second horizontal support members form a generally rectangular, coplanar shape.

In some embodiments, at least one horizontal actuator is disposed between any two of the second horizontal support members. The horizontal actuator positions perpendicularly between the second horizontal support members. From this position, the actuator displaces the second horizontal support members, thereby causing the first horizontal support members to move horizontally. This horizontal movement by the first horizontal support members enables the attached light source to emit a light from different positions and angles onto the cannabis plant.

In some embodiments, a plurality of vertical support members are disposed to intersect the plurality of second horizontal support members at a generally perpendicular relationship. The vertical support members are configured to provide support for the first and second horizontal support members. For example, in one embodiment, four vertical support members position at the corners of the enclosure formed by the second horizontal support members

In some embodiments, at least one vertical actuator is disposed parallel along the length of the plurality of vertical support members. The vertical support members provide support and alignment for the vertical actuator. The vertical actuator is configured to displace the first and second horizontal support members in an up and down movement. This vertical movement enables the light source to emit the light at different heights in relation to the cannabis plant. The vertical movement of the light source may be incrementally slow, or at a steady velocity, depending on the lighting requirements of the cannabis plant. The system enables the rate of the vertical displacement to be controlled for customizable lighting.

In one embodiment, the vertical and horizontal support members form junctions with each other to form a generally rectangular framework. A camber bracket may juxtaposition at the junctions between the vertical support members and the second horizontal support members. The camber bracket helps support the weight of the light source and the first and second horizontal support members. In this manner, deformation, bending, and warping by the first and second horizontal support members is minimized. This helps maintain uniform, even lighting over the cannabis plant.

As discussed above, the horizontal and vertical support members utilize at least one vertical actuator and at least one horizontal actuator for displacement in the respective motions. In one possible embodiment, the system utilizes one vertical actuator that is supported by the parallel vertical support member. The system also utilizes two spaced-apart, parallel horizontal actuators between the second horizontal support members to displace the first horizontal support members in a left and right direction. In one embodiment, the actuators may be powered by an electrical motor. The electric motor may be powered by an efficient power source, such as a Tesla™ battery or a solar panel. Though, in other embodiments, pneumatic power or pressure from hydraulic fluid may power the actuator.

The system further comprises a master controller that is programmed to control the vertical and horizontal movements in a predetermined pattern. For example, without limitation, the light source can be made to move, from left to right, forty-eight inches over a 12 hour period. As discussed above, the displacement of the light source, and thus, the orientation and positioning of the lighting may be customized based on the requirements of the cannabis plant.

In some embodiments, at least one light bracket fastens the light source in its respective positon on the first horizontal support members. The light bracket comprises a mount end for mounting to the first horizontal support member, and a light support end for detachably attaching to the light source. In one embodiment, multiple light brackets are attached along the horizontal support members, spaced-apart at approximately 4 feet. Though, in some embodiments, the light brackets are adjustable to move along the length of the first horizontal support member in any possible pattern and spacing configuration.

The at least one light source is configured to emit lighting onto the cannabis plant in various orientations and power. In one embodiment, the lighting is indoors, and thus, the light source substantially replicates outdoor lighting. The light source may include a housing and a light emitting diode (LED). The housing fastens to the light bracket, protects the LED from damage, and also helps direct the light down onto the cannabis plant.

The LED generates the actual light for the cannabis plant. Those skilled in the art will recognize that an LED is especially effective for the present lighting system because LED's do not generate excessive heat, and do not consume excessive power, as do halogen lamps. In some embodiments, the wattage of the light source is adjustable. In one possible embodiment, the LED may utilize between 600 to 1150 watts to generate the light. The wattage can be adjusted while the horizontal and vertical support members are moving the light source, or while the light source is stationary. Furthermore, because the light source utilizes an LED, a light ballast is integrated into the light source for controlling the starting and operating voltage for the LED.

A master controller is used to control the movement of the light source, the wattage of the LED, and the overall powering on and off for the system. The master controller may also be used to regulate other parameters associated with growing cannabis plants, including, without limitation, temperature, humidity, dew point, moisture content, and water filtration. These parameter are visible on a digital display screen. The system further comprises a timer. The timer can be set to initiate the horizontal and vertical actuators for moving the appropriate support members, and to adjust the wattage at predetermined intervals. At least one switch operates the directional movement, wattage, power, and other parameters for the system. In one alternative embodiment, the master controller is operable by remote control.

In one exemplary embodiment, the master controller can be programmed so that the vertical support members can adjust upward or downward, depending on the height of the plants below the light source, while the wattage increases from 600 watts to 1150 watts. In addition, the light source can be made to move, from left to right, forty-eight inches over a 12 hour period, without limitation. As discussed above, the directional movement, wattage, and power can be controlled and customized to match the needs of the respective cannabis plant below the light source.

The system may further include a program memory for storing a preprogrammed lighting program that is executed by a microprocessor to read the preprogrammed lighting program, and to adjust the wattage of the LED, and trigger the horizontal and vertical actuators for the appropriate horizontal and vertical displacement.

One objective of the present invention is to optimize the growth of at least one cannabis plant by providing uniform lighting.

Another objective of the present invention is to preprogram a master controller to displace at least one light source in a horizontal direction and a vertical direction.

Another objective of the present invention is to preprogram a master controller to adjust the wattage of an LED.

Yet another objective of the present invention is to view the wattage and temperature on a display screen on the master controller.

Yet another objective of the present invention is to adjust the horizontal and vertical displacements with at least one switch on the master controller.

Yet another objective of the present invention is to maintain the first horizontal support members substantially level, so as to provide uniform lighting to the cannabis plant.

Yet another objective is to use at least one camber bracket at the intersection between the second horizontal support member and the vertical support member to maintain the even disposition.

Yet another objective of the present invention is to minimize heat while lighting at least one cannabis plant by using an LED.

Yet another objective is to reduce power consumption by the power source through use of renewable energy sources, such as a Tesla™ battery or a solar panel.

Yet another objective of the present invention is to incrementally displace the light source horizontally and vertically over a duration.

Yet another objective is to detect the temperature proximal to the cannabis plant with a temperature sensor.

Yet another objective is to provide a lighting system that is inexpensive to manufacture and easy to operate.

### DRAWINGS

These and other features, aspects, and advantages of the present invention will become better understood with regard to the following description, appended claims, and drawings where:

FIG. 1 is a perspective view of an exemplary automated lighting system horizontally displaced to the right, in accordance with an embodiment of the present invention;

FIG. 2 is a perspective view of an exemplary automated lighting system horizontally displaced to the left, in accordance with an embodiment of the present invention;

FIG. 3 is a perspective view of an exemplary automated lighting system vertically displaced in an up position, in accordance with an embodiment of the present invention;

FIG. 4 is a perspective view of an exemplary automated lighting system vertically displaced in a down position, in accordance with an embodiment of the present invention;

FIGS. 5A, 5B, and 5C are close-up view of an exemplary vertical actuator and a horizontal actuator, in accordance with an embodiment of the present invention;

FIG. 6 is a top view of an exemplary master controller, in accordance with an embodiment of the present invention; and

FIG. 7 is a block diagram depicting an exemplary client/server system which may be used by an exemplary web-enabled/networked embodiment

### DESCRIPTION

The present invention is directed to an automated system 100, hereafter, “system 100” that enables uniform growth of at least one cannabis plant by preprogramming the lighting to emit light in a desired pattern and wattage. The system 100 is automated, such that the displacement and wattage of at least one light source 116 over the cannabis plant does not require manual intervention. Specifically, the positioning of the light source 116 over the cannabis plant, and the wattage of a light emitting diode (LED) that emits the lighting are preprogrammed to desired specifications that conform to the needs of the cannabis plant. In this manner, the cannabis plant receives a consistent, uniform amount of light without the element of human error; and thereby optimal growth and desired outcome for the cannabis plant is achieved.

The cannabis plant may include a medical cannabis plant. Those skilled in the art will recognize that medicinal compounds, herbs, and medicines in general must be pure and consistent between dosages. Thus, the system 100 provides consistent and customizable lighting conditions that are efficacious for growing consistent yields of medical cannabis.

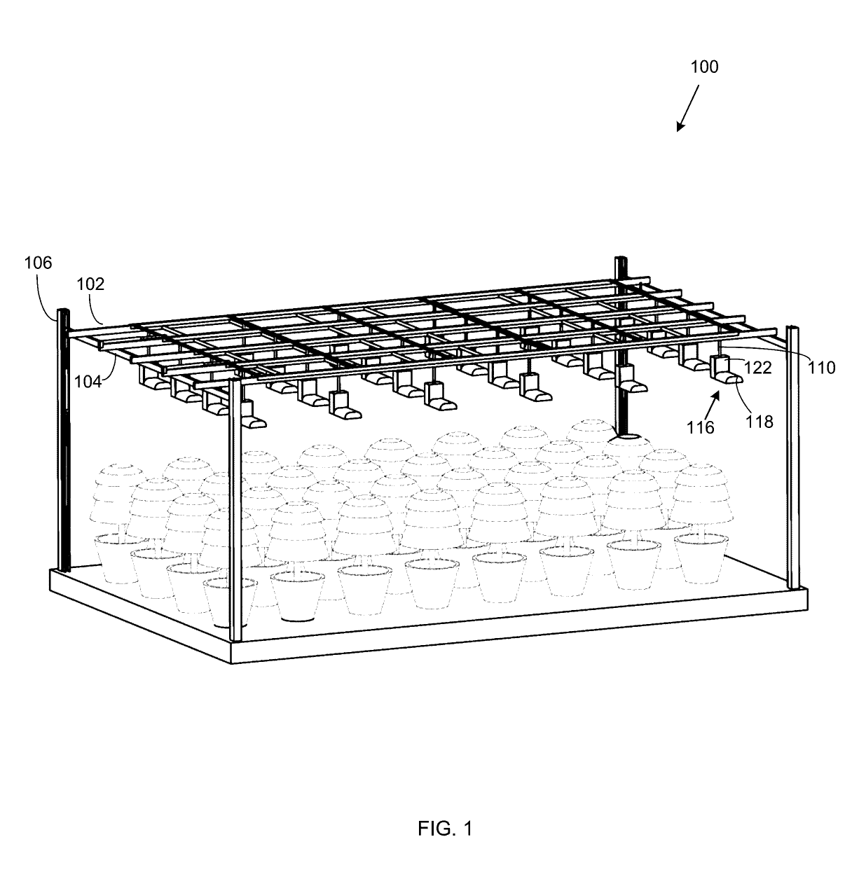

As referenced in FIG. 1, the horizontal and vertical displacement of the light source 116 is performed through a plurality of horizontal support members and a plurality of vertical support members 106 that interact to displace the at least one light source 116 horizontally in a left and right direction, and vertically in an up and down positon. Suitable materials for the horizontal and vertical support member may include, without limitation, aluminum, steel, iron, metal alloys, bamboo, and wood.

The support members are displaced with at least one horizontal actuator 120 and at least one vertical actuator 130, respectively. The actuators are disposed to communicate with the support members directly. A camber bracket 108 at the junction between the horizontal and vertical support members 106 supports the weight of the light source 116 and the horizontal support members, such that the horizontal support member remains level. This enables the light source 116 to emit light uniformly onto the cannabis plant. The master controller 124 is preprogramed to displace the light source 116, set a timer to emit light for a duration, and adjust the wattage of an LED. The power source is efficient and may be renewable energy, so as to help minimize power usage. A microprocessor stores and executes preprogrammed lighting instructions for controlling the actuators and the wattage of the LED.

In some embodiments, the system 100 provides indoor lighting for growing at least one cannabis plant under consistent and uniform lighting conditions. The components of the system 100 are preprogrammed, and thereby automated. Because the system 100 is automated, the proximity and position of the light source 116 relative to the cannabis plant adjusts without requiring manual intervention. In this manner, human error is minimized while growing the cannabis plant, and the final yield and consistency of the cannabis plant is optimized.

The adjustable positioning of the light source 116 involves both horizontal and vertical displacement of the light source 116. The adjustability of the wattage for the light source 116 is also automated. The proximity, horizontal position, and wattage of the light source 116 may be simultaneously or independently adjusted. Furthermore, the system 100 enables automation for powering on and off the light source 116, and timing the duration of the light. In this manner, the overall lighting needs of the cannabis plant are automated and adjustable to maintain a uniform, customizable lighting system 100. This consequently grows cannabis plants with enhanced consistency and yield.

Turning now to FIG. 1, the system 100 includes a plurality of first horizontal support members 102. The first horizontal support members 102 are configured to carry the at least one light source 116. The first horizontal support members 102 are disposed in a parallel spaced-apart relationship. In one embodiment, five parallel, evenly-spaced parallel first horizontal support members 102 extend longitudinally. The first horizontal support members 102 are configured to be telescopically displaced in a horizontal direction. The horizontal displacement includes a left and right movement.

In one possible embodiment, the first horizontal support members 102 are configured into a rail configuration. For example, a pair of aligned first horizontal support members 102 freely slide in and out of each other, enabling a telescopic interaction in a horizontal direction. The horizontal movement may be incrementally slow, or movement at a steady rate, depending on the lighting requirements of the cannabis plant. The system 100 enables the rate of the horizontal displacement to be preprogrammed and adjustably controlled for customizable lighting.

In one exemplary embodiment, the first horizontal support members 102 support multiple light sources 116 that are disposed in a spaced-apart relationship above multiple cannabis plants. From this configuration, the light source 116 is programmed to emit light onto the cannabis plant from multiple angles, heights, and wattages. Furthermore, the at least one light source 116 is maintained in a substantially level disposition relative to the cannabis plant. This creates a uniform transmission of light, which optimizes growth of the cannabis plant.

In some embodiments, a plurality of second horizontal support members 104 are disposed in a coplanar and perpendicular relationship to the first horizontal support members 102. The second horizontal support members 104 form a pair of ends at the termini of the first horizontal support members 102. In one embodiment, the first and second horizontal support members 104 may form a generally rectangular, coplanar shape. The first horizontal support members 102 align parallel and longitudinally, and the second horizontal support members 104 form ends to form a coplanar enclosure. Various fasteners may be used to fasten together the first and second horizontal support members 104. The fasteners may include, without limitation, all-through bolts, nuts, screws, bolts, and welding

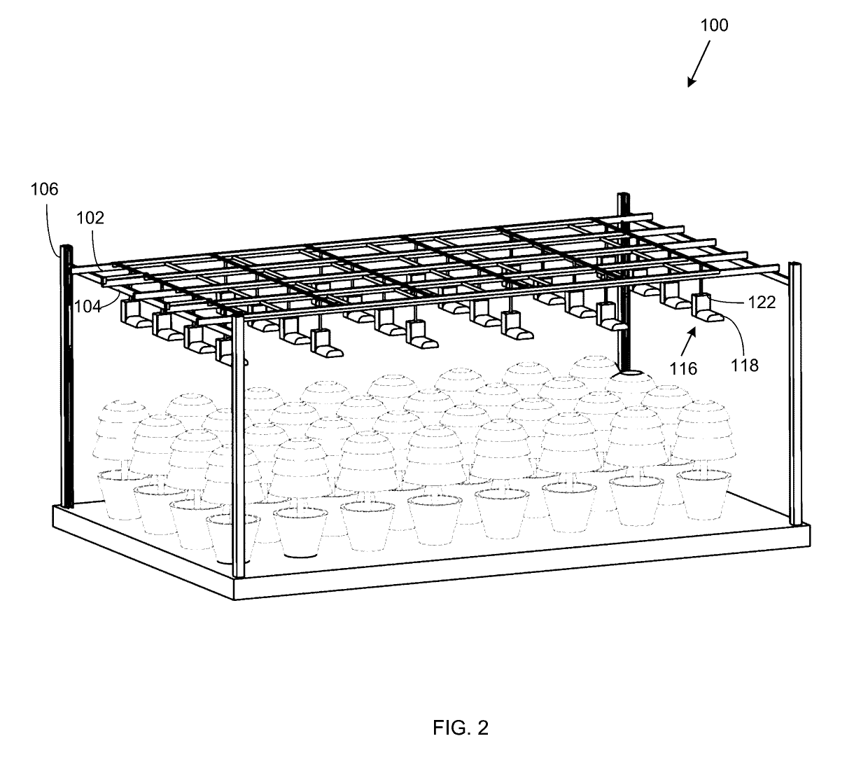

In some embodiments, at least one horizontal actuator 120 is disposed between any two of the second horizontal support members 104. The horizontal actuator 120 positions perpendicularly between the second horizontal support members 104. From this position, the actuator displaces the second horizontal support members 104, thereby causing the first horizontal support members 102 to move horizontally, such as from a left to a right positon (FIGS. 1 and 2). This horizontal movement by the first horizontal support members 102 enables the attached light source 116 to emit a light from different positions and angles onto the cannabis plant.

In some embodiments, a plurality of vertical support members 106 are disposed to intersect the plurality of second horizontal support members 104 at a generally perpendicular relationship. The vertical support members 106 are configured to provide support for the first and second horizontal support members 104. For example, in one embodiment, four vertical support members 106 position at the corners of the enclosure formed by the second horizontal support members 104. Various fasteners, including, all-through bolts, nuts, screws, bolts, and welding may be used to fasten together the first and second horizontal support members 104 to the vertical support members 106.

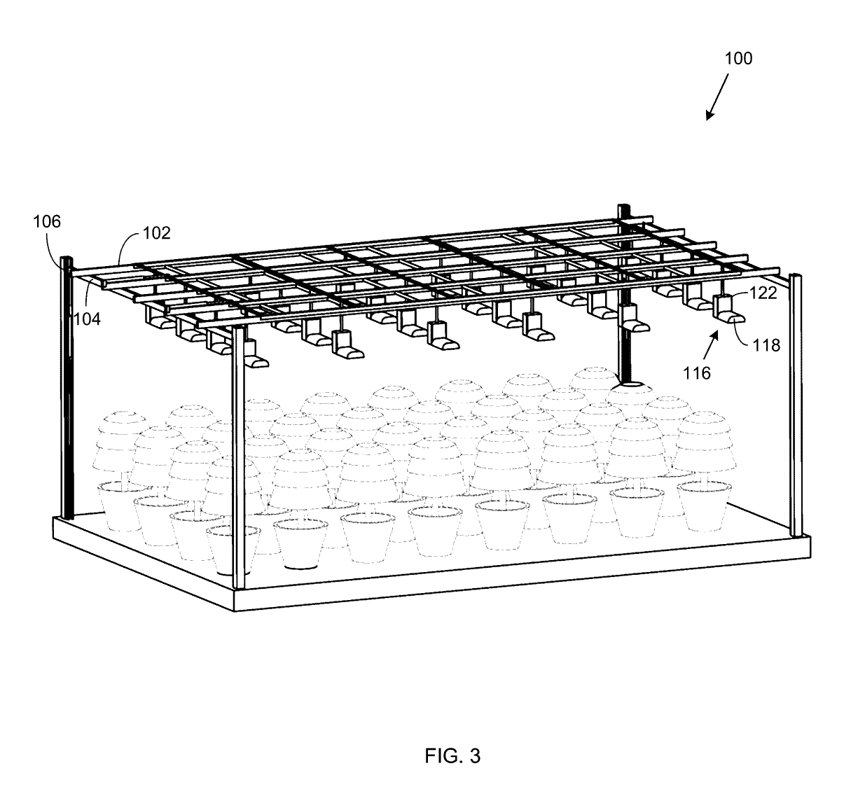

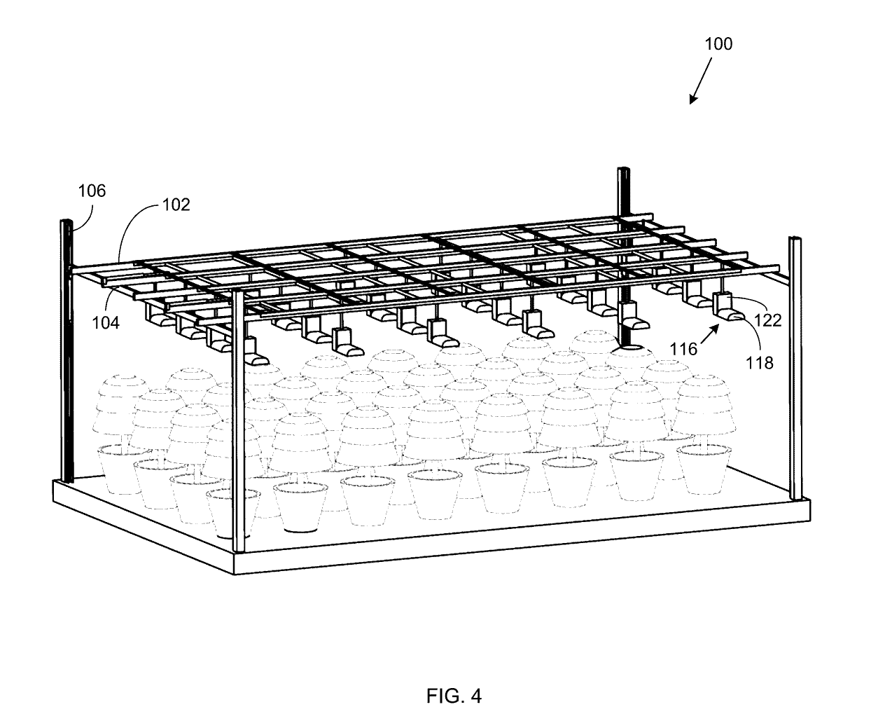

In some embodiments, at least one vertical actuator 130 is disposed parallel along the length of the plurality of vertical support members 106. The vertical support members 106 provide support and alignment for the vertical actuator 130. The vertical actuator 130 is configured to displace the first and second horizontal support members 104 in an up and down movement. This vertical movement enables the light source 116 to emit the light at different heights in relation to the cannabis plant. The vertical movement of the light source 116 may be incrementally slow, or at a steady velocity, depending on the lighting requirements of the cannabis plant. The system 100 enables the rate of the vertical displacement to be controlled for customizable lighting. For example, FIG. 3 illustrates the vertical support members 106 displaced in an upward position, while FIG. 4 illustrates the vertical support members 106 displaced in a down position.

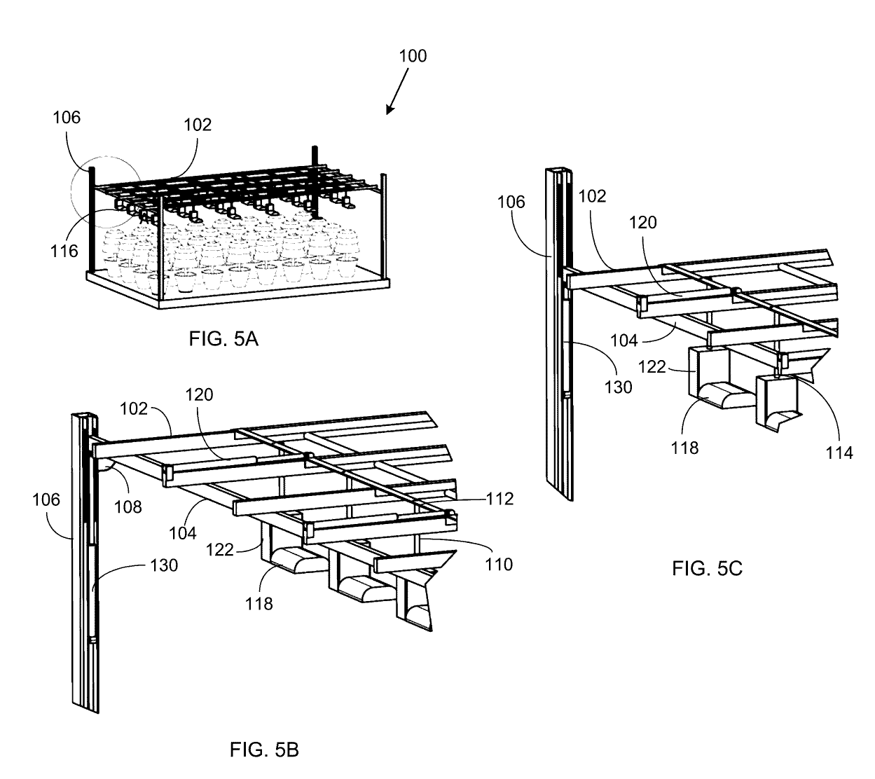

As illustrated in FIGS. 5A, 5B, and 5C, the vertical and horizontal support members form junctions with each other to form a generally rectangular framework. A camber bracket 108 may juxtaposition at the junctions between the vertical support members 106 and the second horizontal support members 104. The camber bracket 108 helps support the weight of the light source 116 and the first and second horizontal support members 104. In this manner, deformation, bending, and warping by the first and second horizontal support members 104 is minimized. This helps maintain a uniform light over the cannabis plant.

As discussed above, the horizontal and vertical support members 106 utilize at least one vertical actuator 130 and at least one horizontal actuator 120 for displacement in the respective motion. In one possible embodiment, the system 100 utilizes one vertical actuator 130 that is supported by the parallel vertical support member. The system 100 may also utilize two spaced-apart, parallel horizontal actuator 120s between the second horizontal support members 104 to displace the first horizontal support members 102 in a left and right direction. In one embodiment, the actuators may be powered by an electrical motor. The electric motor may be powered by an efficient power source, such as a Tesla™ battery or a solar panel. Though, in other embodiments, pneumatic power or pressure from hydraulic fluid may power the actuator.

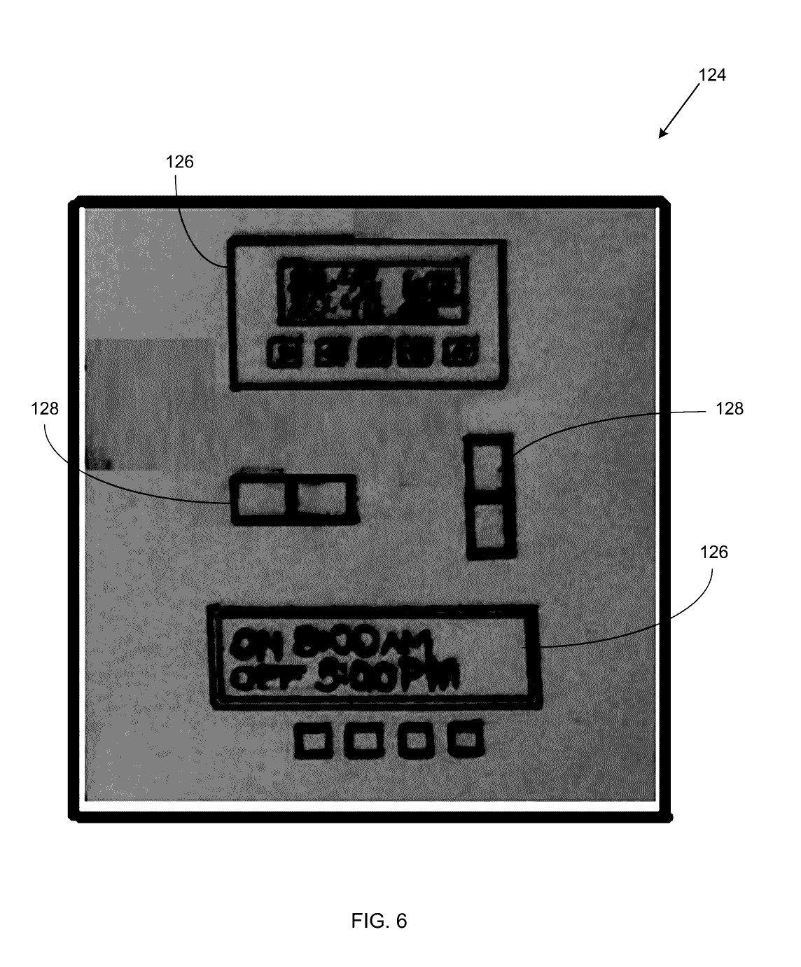

Turning now to FIG. 6, the system 100 further comprises a master controller 124 that is programmed to control the vertical and horizontal movements in a predetermined pattern. In a preferred embodiment of the present invention, the displacement of the light source 116, and thus, the orientation and positioning of the lighting is preprogrammed and customized based on the requirements of the cannabis plant.

In some embodiments, at least one light bracket 110 fastens the light source 116 in its respective positon on the first horizontal support members 102. The light bracket 110 comprises a mount end 112 for mounting to the first horizontal support member, and a light support end 114 for detachably attaching to the light source 116. In one embodiment, multiple light bracket 110s are attached along the horizontal support members, spaced-apart at approximately 4 feet. Though, in some embodiments, the light brackets 110 are adjustable to move along the length of the first horizontal support member in any possible pattern and spacing configuration. In one embodiment, each light bracket 110 may include a planar, rectangular sheet of rigid metal having multiple fastening holes.

The at least one light source 116 is configured to emit lighting onto the cannabis plant in various orientations and power. In one embodiment, the lighting is indoors, and thus, the light source 116 substantially replicates outdoor lighting. The light source 116 may include a housing 118 and a LED. The housing 118 fastens to the light bracket 110, protects the LED from damage, and also helps direct the light down onto the cannabis plant. The housing 118 includes a protective sidewall and an opening that enables passage of the light. The housing 118 may take any shape, including, without limitation, a dome, a rectangle, a pyramid, a cube, and a sphere.

The LED generates the actual light for the cannabis plant. Those skilled in the art will recognize that an LED is especially effective for the present lighting system 100 because LED's generally don't generate excessive heat, and do not consume excessive power, as would a halogen lamp. The wattage of the light source 116 is adjustable. The wattage can be adjusted while the frame is moving the light source 116, or while the light source 116 is stationary. In one possible embodiment, the LED may utilize between 600 to 1150 watts to generate the light. Furthermore, because the light source 116 utilizes an LED, a light ballast 122 is integrated into the light source 116 for controlling the starting and operating voltage for the LED.

In one exemplary embodiment, the system 100 requires one hundred amps to operate 25 light sources 116. In another exemplary embodiment, the system 100 utilizes 5 10 AWG cords to power 25 light sources 116. In yet another exemplary embodiment, the light source 116 is a Gavita Pro™. Though, any light source 116 that generates sufficient light may be used.

The master controller 124 is used to control the movement of the light source 116, the wattage of the LED, and the overall powering on and off for the system 100. The master controller 124 may also be used to regulate other parameters associated with growing cannabis plants, including, without limitation, temperature, humidity, dew point, moisture content. These parameter are visible on a digital display screen 126. The master controller 124 may include at least one switch 128 for operating the horizontal and vertical actuators 130, the power, and the temperature detection. The switch 128 may include any button, toggle switch 128, clicker, or dial known in the art. The master controller 124 further comprises a display screen 126 that enables viewing of the temperature and wattage. The display screen 126 may be a digital display screen 126. In one alternative embodiment, the master controller 124 is operable by remote control.

In some embodiments, the system 100 may include a microprocessor. In one possible embodiment, the microprocessor is configured to store and execute a preprogrammed lighting program. The preprogrammed lighting program is configured to read a displacement instruction and command the at least one horizontal actuator 120 and the at least one vertical actuator 130 in response to the displacement instruction. Furthermore, the preprogrammed lighting program is configured to read a wattage instruction and command the LED to adjust the wattage in response to the wattage instruction.

The system 100 further comprises a timer. The timer is configured to trigger the microprocessor to command the LED to emit the light for a duration. The timer can also be set to trigger the horizontal and vertical actuator 130s for moving the appropriate support members, and to adjust the wattage at predetermined intervals. For example, the timer enables the horizontal actuator 120 to initiate horizontal displacement for a duration of 12 hours.

In one exemplary embodiment, the master controller 124 can be programmed so that the vertical support members 106 are actuated to start moving vertically in an upward direction that depends on the height of the plants below the light source. The directional movement, wattage, and power can be controlled and customized to match the needs of the respective cannabis plant.

In one alternative embodiment, the system 100 utilizes technical sensors that detect mechanical breakdowns and inoperable components throughout the system 100. For example, the LED has burned out, or the horizontal actuator 120 requires oil or fluid. Upon detection of the malfunctions, the system 100 communicates the problem through text, email, or phone. In this manner, preventive maintenance and emergency repairs are made possible.

In one alternative embodiment, the system 100 may further comprise one or more gas meters for measuring gas levels, i.e., CO₂ and Relative Humidity, in the air surrounding the cannabis plant. The meter is located within a measuring distance in relation to the cannabis plant and is connected to the microprocessor.

In another alternative embodiment, the system 100 further comprises a water filter. The water filter may include a chemical-free water conditioner that softens hard water. The water filter may use an electrical charge to alter the state of particles in the water. This causes scale to precipitate out of the water solution.

In another alternative embodiment, the system 100 further comprises an air flow meter for measuring the air speed in close proximity of the cannabis plant. The air flow meter is electrically connected to the microprocessor. The system 100 may further have a temperature sensor for measuring temperature of the air surrounding the cannabis plant. The temperature sensor is electrically connected to the microprocessor.

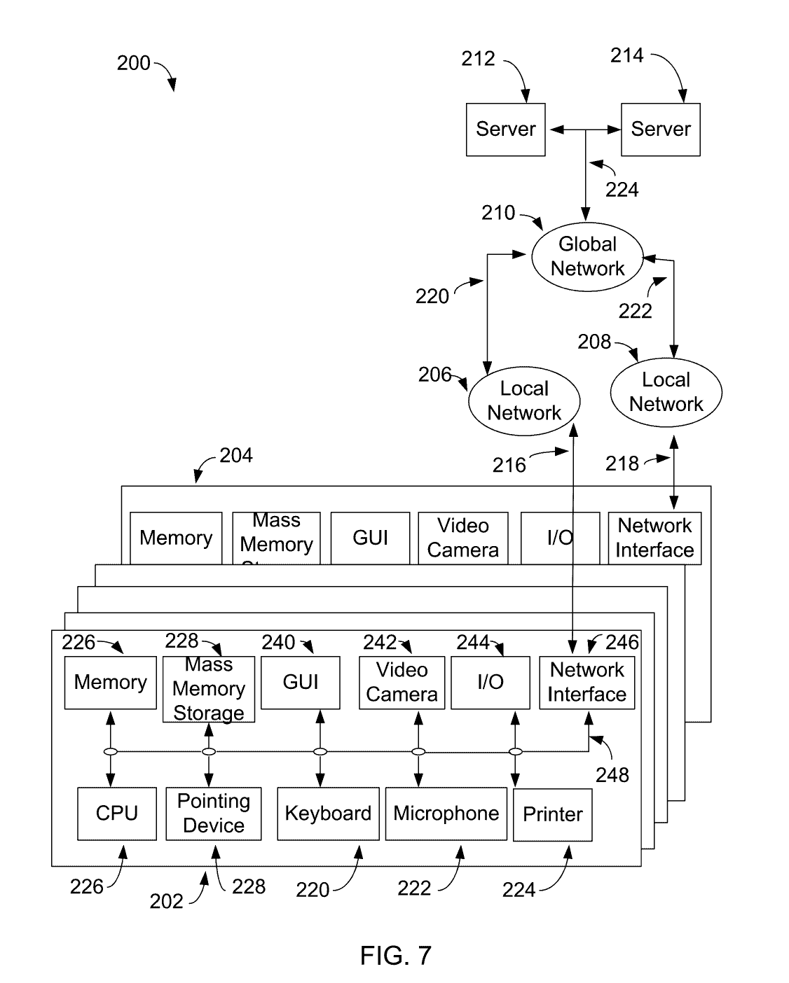

FIG. 7 is a block diagram depicting an exemplary client/server system which may be used by an exemplary web-enabled/networked embodiment of the present invention.

A communication system 200 includes a multiplicity of clients with a sampling of clients denoted as a client 202 and a client 204, a multiplicity of local networks with a sampling of networks denoted as a local network 206 and a local network 208, a global network 210 and a multiplicity of servers with a sampling of servers denoted as a server 212 and a server 214.

Client 202 may communicate bi-directionally with local network 206 via a communication channel 216. Client 204 may communicate bi-directionally with local network 208 via a communication channel 218. Local network 206 may communicate bi-directionally with global network 210 via a communication channel 220. Local network 208 may communicate bi-directionally with global network 210 via a communication channel 222. Global network 210 may communicate bi-directionally with server 212 and server 214 via a communication channel 224. Server 212 and server 214 may communicate bi-directionally with each other via communication channel 224. Furthermore, clients 202, 204, local networks 206, 208, global network 210 and servers 212, 214 may each communicate bi-directionally with each other.

In one embodiment, global network 210 may operate as the Internet. It will be understood by those skilled in the art that communication system 200 may take many different forms. Non-limiting examples of forms for communication system 200 include local area networks (LANs), wide area networks (WANs), wired telephone networks, wireless networks, or any other network supporting data communication between respective entities.

Clients 202 and 204 may take many different forms. Non-limiting examples of clients 202 and 204 include personal computers, personal digital assistants (PDAs), cellular phones and smartphones.

Client 202 includes a CPU 226, a pointing device 228, a keyboard 230, a microphone 232, a printer 234, a memory 236, a mass memory storage 238, a GUI 240, a video camera 242, an input/output interface 244 and a network interface 246.

CPU 226, pointing device 228, keyboard 230, microphone 232, printer 234, memory 236, mass memory storage 238, GUI 240, video camera 242, input/output interface 244 and network interface 246 may communicate in a unidirectional manner or a bi-directional manner with each other via a communication channel 248. Communication channel 248 may be configured as a single communication channel or a multiplicity of communication channels.

CPU 226 may be comprised of a single processor or multiple processors. CPU 226 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

As is well known in the art, memory 236 is used typically to transfer data and instructions to CPU 226 in a bi-directional manner. Memory 236, as discussed previously, may include any suitable computer-readable media, intended for data storage, such as those described above excluding any wired or wireless transmissions unless specifically noted. Mass memory storage 238 may also be coupled bi-directionally to CPU 226 and provides additional data storage capacity and may include any of the computer-readable media described above. Mass memory storage 238 may be used to store programs, data and the like and is typically a secondary storage medium such as a hard disk. It will be appreciated that the information retained within mass memory storage 238, may, in appropriate cases, be incorporated in standard fashion as part of memory 236 as virtual memory.

CPU 226 may be coupled to GUI 240. GUI 240 enables a user to view the operation of computer operating system and software. CPU 226 may be coupled to pointing device 228. Non-limiting examples of pointing device 228 include computer mouse, trackball and touchpad. Pointing device 228 enables a user with the capability to maneuver a computer cursor about the viewing area of GUI 240 and select areas or features in the viewing area of GUI 240. CPU 226 may be coupled to keyboard 230. Keyboard 230 enables a user with the capability to input alphanumeric textual information to CPU 226. CPU 226 may be coupled to microphone 232. Microphone 232 enables audio produced by a user to be recorded, processed and communicated by CPU 226. CPU 226 may be connected to printer 234. Printer 234 enables a user with the capability to print information to a sheet of paper. CPU 226 may be connected to video camera 242. Video camera 242 enables video produced or captured by user to be recorded, processed and communicated by CPU 226.

CPU 226 may also be coupled to input/output interface 244 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 226 optionally may be coupled to network interface 246 which enables communication with an external device such as a database or a computer or telecommunications or internet network using an external connection shown generally as communication channel 216, which may be implemented as a hardwired or wireless communications link using suitable conventional technologies. With such a connection, CPU 226 might receive information from the network, or might output information to a network in the course of performing the method steps described in the teachings of the present invention.

While the inventor's above description contains many specificities, these should not be construed as limitations on the scope, but rather as an exemplification of several preferred embodiments thereof. Many other variations are possible. For example, the support members could be extended diagonally, rather than longitudinally. Accordingly, the scope should be determined not by the embodiments illustrated, but by the appended claims and their legal equivalents.

What is claimed is:

1. An automated system for uniform growth of medical cannabis, the system comprising:
a plurality of first horizontal support members, the plurality of first horizontal support members disposed in a parallel spaced-apart relationship, the plurality of first horizontal support members configured to telescopically move in a horizontal direction;
a plurality of second horizontal support members, the plurality of second horizontal support members disposed in a coplanar and perpendicular relationship to the plurality of first horizontal support members;
at least one horizontal actuator, the at least one horizontal actuator disposed in a perpendicular relationship between the plurality of second horizontal support members, the at least one horizontal actuator configured to horizontally displace the plurality of first horizontal support members;
a plurality of vertical support members, the plurality of vertical support members disposed to intersect the plurality of second horizontal support members in a generally perpendicular relationship;
at least one vertical actuator, the at least one vertical actuator disposed parallel along the length of the plurality of vertical support members, the at least one vertical actuator configured to vertically displace the plurality of first horizontal support members and the plurality of second horizontal support members;
at least one light bracket, the at least one light bracket having a mount end and a light support end, the mount end configured to attach to the plurality of first horizontal support members in a spaced-apart relationship;
at least one light source;
at least one camber bracket, the at least one camber bracket disposed to position at the intersection between the plurality of second horizontal support members and the plurality of vertical support members, the at least one camber bracket configured to provide support for the plurality of first horizontal support members and the at least one light source, wherein the support from the at least one camber bracket maintains the plurality of first horizontal support members in a substantially level configuration, such that the light from the light emitting diode is uniformly emitted;
a master controller, the master controller configured to control and monitor the horizontal displacement by the plurality of first horizontal support members, the master controller further configured to control and monitor the vertical displacement by the plurality of vertical support members, the master controller further configured to control and monitor a wattage for the light emitting diode;
a microprocessor, the microprocessor configured to store and execute a preprogrammed lighting program, the preprogrammed lighting program configured to read a displacement instruction and command the at least one horizontal actuator and the at least one vertical actuator in response to the displacement instruction, the preprogrammed lighting program further configured to read a wattage instruction and command the light emitting diode to adjust the wattage in response to the wattage instruction; and
a timer, the timer configured to trigger the microprocessor to command the light emitting diode to emit the light for a duration.

2. The system of claim 1, wherein the light source comprises of a housing and a light emitting diode, the housing configured to attach to the light support end of the at least one light bracket, and the light emitting diode configured to emit a light, and wherein the system is configured to provide uniform light for at least one cannabis plant.

3. The system of claim 1, wherein the plurality of first horizontal support members are elongated and configured in a sliding rail configuration.

4. The system of claim 1, wherein the plurality of second horizontal support members are elongated.

5. The system of claim 1, wherein the plurality of vertical support members are elongated.

6. The system of claim 1, wherein the plurality of first horizontal support members, the plurality of second horizontal support members, and the plurality of vertical support members are fabricated from aluminum.

7. The system of claim 1, wherein the at least one horizontal actuator and the at least one vertical actuator is an electric vertical actuator are electrical.

8. The system of claim 1, wherein the horizontal displacement is a left and right direction.

9. The system of claim 1, wherein the vertical displacement is an up and down direction.

10. The system of claim 1, further including an electric motor.

11. The system of claim 10, wherein the electric motor powers the at least one horizontal actuator and the at least one vertical actuator.

12. The system of claim 11, further including a power source.

13. The system of claim 12, wherein the power source is an energy efficient battery or a solar panel.

14. The system of claim 13, further including a light ballast.

15. The system of claim 14, wherein the wattage of the light source is a metal halide light source.

16. The system of claim 15, wherein the master controller has a display screen and at least one switch.

17. The system of claim 16, further including a temperature sensor.

18. The system of claim 17, further including a remote control.

19. The system of claim 18, wherein the remote control is configured to operate the master controller.

20. An automated system for uniform growth of medical cannabis, the system comprising:
a plurality of first horizontal support members, the plurality of first horizontal support members disposed in a parallel spaced-apart relationship, the plurality of first horizontal support members configured to telescopically move in a horizontal direction;
a plurality of second horizontal support members, the plurality of second horizontal support members disposed in a coplanar and perpendicular relationship to the plurality of first horizontal support members;
at least one horizontal actuator, the at least one horizontal actuator disposed in a perpendicular relationship between the plurality of second horizontal support members, the at least one horizontal actuator configured to horizontally displace the plurality of first horizontal support members;
a plurality of vertical support members, the plurality of vertical support members disposed to intersect the plurality of second horizontal support members in a generally perpendicular relationship;
at least one vertical actuator, the at least one vertical actuator disposed parallel along the length of the plurality of vertical support members, the at least one vertical actuator configured to vertically displace the plurality of first horizontal support members and the plurality of second horizontal support members;
an electric motor, the electric motor configured to power the at least one horizontal actuator and the at least one vertical actuator;
at least one light bracket, the at least one light bracket having a mount end and a light support end, the mount end configured to attach to the plurality of first horizontal support members in a spaced-apart relationship;
at least one light source, that at least one light source having a housing and a light emitting diode, the housing configured to attach to the light support end of the at least one light bracket, the light emitting diode configured to emit a light;
at least one camber bracket, the at least one camber bracket disposed to position at the intersection between the plurality of second horizontal support members and the plurality of vertical support members, the at least one camber bracket configured to provide support for the plurality of first horizontal support members and the at least one light source, wherein the support from the at least one camber bracket maintains the plurality of first horizontal support members in a substantially level configuration, such that the light from the light emitting diode is uniformly emitted;
a power source, the power source configured to provide energy to the electric motor and the at least one light source, the power source further configured to be energy efficient;
a temperature sensor, the temperature configured to detect a temperature;
a master controller, the master controller configured to regulate the horizontal displacement by the plurality of first horizontal support members, the master controller further configured to regulate the vertical displacement by the plurality of vertical support members, the master controller further configured to regulate a wattage for the light emitting diode, the master controller further configured to display a temperature and the duration of the emitted light;
a microprocessor, the microprocessor configured to store and execute a preprogrammed lighting program, the preprogrammed lighting program configured to read a displacement instruction and command the at least one horizontal actuator and the at least one vertical actuator in response to the displacement instruction, the preprogrammed lighting program further configured to read a wattage instruction and command the light emitting diode to adjust the wattage in response to the wattage instruction; and
a timer, the timer configured to trigger the microprocessor to command the light emitting diode to emit the light for a duration.
